(19) United States
(12) Patent Application Publication
(10) Pub. No.: US 2010/0053124 A1
(43) Pub. Date: Mar. 4, 2010

(54) DIGITAL PHOTO FRAME WITH MIRROR FUNCTION

(75) Inventors: MING-FENG TSAI, Tu-Cheng (TW); CHENG-HAO CHOU, Tu-Cheng (TW); KUAN-HONG HSIEH, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, ShenZhen City (CN); HON HAI PRECISION INDUSTRY CO., LTD., Tu-Cheng (TW)

(21) Appl. No.: 12/479,696

(22) Filed: Jun. 5, 2009

(30) Foreign Application Priority Data
Sep. 3, 2008 (CN) 200820302007.9

(51) Int. Cl. G09G 5/00; G06F 1/00; G06F 11/30

(52) U.S. Cl. 345/204; 713/340; 340/573.1

(57) ABSTRACT

A digital photo frame (DPF) includes a power source, a power management unit, a display panel, a backlight unit, a motion detector and a processing unit. The display panel includes a reflective structure. The power management unit is used to manage the power supply from the power source to the DPE The backlight unit connects with the display panel and the power management unit. The motion detector is used to produce a detection signal when detecting there is someone around the DPF within a relatively short range. The processing unit connects with the motion detector and the power management unit, when the processing unit receives the detection signal, the processing unit controls the power management unit to discontinue the power from the power source to the backlight unit, therefore display panel reflects images via the reflective structure.

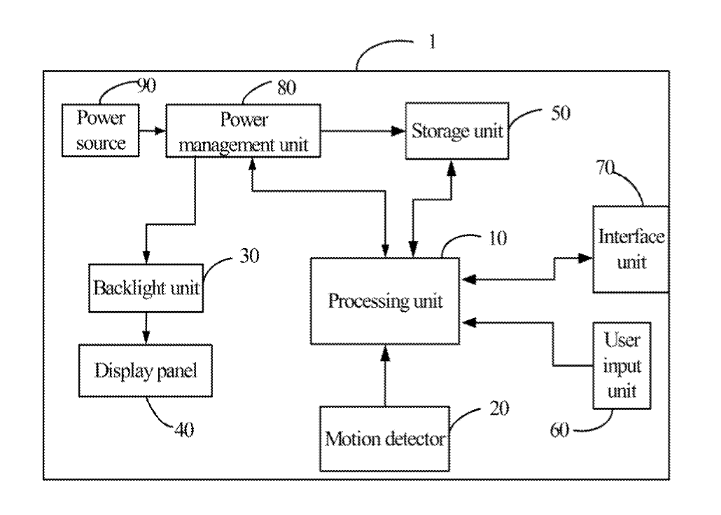

### RELATED APPLICATIONS

This application is related to copending applications entitled, “DIGITAL PHOTO FRAME WITH MIRROR FUNCTION”, filed ______ (Atty. Docket No. US 22328); and “DIGITAL PHOTO FRAME WITH MIRROR FUNCTION”, filed ______ (Atty. Docket No. US22331).

### BACKGROUND

1. Technical Field

The disclosure relates to electronic devices and, particularly, to a digital photo frame.

2. Description of Related Art

Nowadays, digital photos are getting more and more popular while digital cameras are becoming more and more affordable. Accordingly, in order to display digital photos, digital photo frames (DPFs) are invented.

Like the traditional photo frames, many DPFs can be either placed on a table or mounted on a wall. Because of their popularity, it would be useful if DPFs could serve other purposes as well.

Therefore, it is useful to provide a digital photo frame with additional functionality.

### BRIEF DESCRIPTION OF THE DRAWINGS

The components in the drawing is not necessarily drawn to scale, the emphasis instead being placed upon clearly illustrating the principles of the digital photo frame.

The drawing is a block diagram of a digital photo frame in accordance with an exemplary embodiment.

### DETAILED DESCRIPTION

Referring to the drawing, a digital photo frame (DPF) 1 includes a processing unit 10, a motion detector 20, a backlight unit 30, a display panel 40, a storage unit 50, a user input unit 60, an interface unit 70 (e.g., an input port or a wireless transceiver), a power management unit 80, and a power source 90.

The interface unit 70 is configured to connect to an external electronic device (not shown). The external device can be a storage card (e.g., a secure digital SD card, a compact flash CF card) or another electronic device (e.g., a digital camera, a mobile phone, or a computer).

The user input unit 60 is configured to generate instructions in response to user operations. The user input unit 60 can be input keys/buttons, knobs, and the like. The power management unit 80 is configured to distribute power from the power source 90 to elements of the DPF 1, such as the processing unit 10, the backlight unit 30 and the display panel 40.

The storage unit 50 is configured to store medias such as digital pictures. The display panel 40 is configured to display the medias. The backlight unit 30 is configured to illuminate the display panel 40 from the side or back of the display panel 40. The backlight unit 30 can be incandescent light bulbs, light-emitting diodes (LEDs), an electroluminescent panel (ELP), one or more cold cathode fluorescent lamps (CCFL), and hot cathode fluorescent lamps (HCFL), or the like.

In the embodiment, the display panel 40 is a multilayer panel. One layer excepting the surface of the display panel 40 is plated with reflective material, such as aluminum, bronze, and silver, and so on. The reflective material enables the display panel 40 to reflect images like a mirror when the backlight unit 30 is turned off.

In another embodiment, the surface of the display panel 40 is covered with a reflective film. The film can be an aluminum plated film, a silver plated film, a bronze plated film, or the like.

The motion detector 20, connected to the processing unit 10, is configured for detecting whether there is a person around the DPF 1 within a relatively short range (e.g., 0.2 meter) and producing a detection signal to the processing unit 10 when there is one. The processing unit 10 is configured to control the power management unit 80 to discontinue the power from the power source 90 to the backlight unit 30 when receiving the detection signal. Then the backlight unit 30 is turned off and the display panel 40 can be used as a mirror by the person.

In the embodiment, the motion detector 20 continuously detects whether there is still someone around the DPF 1 within the relatively short range. The motion detector 20 is also configured to produce a power-on signal when it detects that nobody is within the relatively short range. The processing unit 10 controls the power management unit 80 to provide power from the power source 90 to the backlight unit 30 when receiving the power-on signal. Then, the display panel 40 displays the media again when there is nobody right before the DPF 1 seeking to see their reflection.

The motion detector 20 may include any one or more of the following, an infrared detector, a sonar detector, an audio detector, or the like, which can work singly or in combination according to preset parameters to generate a signal when it is likely one or more persons are present in the predetermined area.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A digital photo frame (DPF) comprising:
a power management unit connected to a power source, configured for distributing power from the power source to the DPF;
a display panel comprising a reflective structure;
a backlight unit connected to the power management unit, configured for illuminating the display panel when tuned on;
a motion detector configured for detecting whether there is a person around the DPF within a relatively short range and producing a detection signal if there is one; and
a processing unit connected to the motion detector, configured for controlling the power management unit discontinue power from the power source to the backlight when receiving the detection signal.

2. The DPF of claim 1, wherein the motion detector continuously detects whether there is someone around the DPF, if the motion detector detects nobody around the DPF with the relatively short range, the motion detector produces a power-on signal, and the processing unit is further configured for controlling the power management unit to provide power to the backlight unit when receiving the power-on signal.

3. The DPF of claim 1, wherein the display panel comprises a multilayer structure, and the reflective structure is one layer excepting the surface layer of the display panel plated with a reflective material.

4. The DPF of claim 3, wherein the reflective material is selected from the group consisting of aluminum, bronze, and silver.

5. The DPF of claim 1, wherein reflective structure is a reflective film covering the display panel, and the reflective film comprises a multilayer structure and one layer excepting the surface of the reflective film is plated with reflective material.

6. The DPF of claim 5, wherein the reflective material is selected from the group consisting of aluminum, bronze, and silver.

7. The DPF of claim 2, wherein the motion detector comprises one selected from the group consisting of an infrared detector, a sonar detector, and an audio detector.

8. The DPF of claim 2, wherein the motion detector comprises two or more detectors selected from the group consisting of an infrared detector, a sonar detector, and an audio detector; the detectors can work singly or in combination according to preset parameters to generate a signal when a person is sensed present in the predetermined area.

9. A method of changing the display state of a digital photo frame (DPF), the DPF comprising:
a power management unit;
a display panel comprising a reflective structure;
a motion detector;
a processing unit,
the method comprising:
detecting whether there is a person around the DPF via the motion detector;
producing a detection signal when the motion detector detects that there is a person around the DPF; and
controlling the power management unit to discontinue the power from a power source to the backlight unit when the processing unit receives the detection signal, thereby, the backlight unit is turned off and the display panel reflect image via the reflective structure.

10. The method of claim 9, further comprising:
producing a power-on signal via the motion detector when it detects there is nobody around the DPF;
controlling the power management unit to provide the power from the power source to the backlight unit when the processing unit receives the power-on signal.
